(19) United States
(12) Patent Application Publication
(10) Pub. No.: US 2025/0225520 A1
(43) Pub. Date: Jul. 10, 2025

(54) FACILITATING PAYMENTS IN AN EXTENDED REALITY SYSTEM BASED ON BEHAVIORAL BIOMETRICS

(71) Applicant: MASTERCARD INTERNATIONAL INCORPORATED, PURCHASE, NY (US)

(72) Inventors: Travis J. MAY, Warrenton, MO (US); Andrew Carey JOYCE, Wicklow Town (IE); Briana BECK, Irvine, CA (US)

(21) Appl. No.: 19/093,088

(22) Filed: Mar. 27, 2025

Related U.S. Application Data
(63) Continuation of application No. 17/548,350, filed on Dec. 10, 2021.
(60) Provisional application No. 63/124,718, filed on Dec. 12, 2020.

(51) Int. Cl. G06Q 20/40; G06F 3/01; G06F 40/279

(52) U.S. Cl. CPC G06Q 20/40145; G06F 3/011; G06F 40/279

(57) ABSTRACT

The disclosure herein describes enabling transactions from within an extended reality (XR) system using behavioral biometrics. A user using the XR system is detected and behavioral biometric data of the user is automatically collected. A user profile is identified based on the biometric data, wherein the user profile is associated with a subset of content and payment data. Access to the content is provided to the user via the XR system. A transaction request is received that is associated with the content. Based on the transaction request, behavioral biometric data of the user is automatically collected again. The association between the biometric data and the user profile is verified. Based on verifying that the second biometric token is associated with the user profile, a transaction is initiated based on the transaction request, whereby a transaction processing entity is configured to authenticate the user based on the biometric data and facilitate the transaction.

### CROSS-REFERENCE TO RELATED APPLICATIONS

This application claims is a continuation of and claims the benefit of U.S. Non Provisional Application No. 17/548,350 filed Dec. 10, 2021, entitled “Facilitating Payments In An Extended Reality System Based On Behavioral Biometrics”, which claims priority to U.S. Provisional Application No. 63/124,718 filed Dec. 12, 2020, entitled “Facilitating Payments In An Extended Reality System Based On Behavioral Biometrics”, the entireties of which are hereby incorporated by reference herein.

### BACKGROUND

The Extended Reality (XR) market (e.g., Augmented Reality (AR), Virtual Reality (VR), Mixed Reality (MR)) has grown exponentially over the past few years and is showing considerable promise for future e-commerce and retail opportunities. The growing interest in this market has led to the development of e-commerce experiences from stand-alone shopping venues to in-scenario purchases-driven by start-ups, industry giants, and companies in between. Given the digital nature of the medium and transaction, safe and seamless methods of conducting the transactions within immersive environments are increasingly necessary. Authentication will be at the center of conducting safe transactions and maintaining the immersive nature of the content while enabling safe transactions presents a substantial challenge that is vital to overcome.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for enabling processing of transactions from within an XR system using behavioral biometrics is described. A user using the XR system is detected and a first set of biometric data of the user is automatically collected, wherein the first set of biometric data includes biometric data of at least one behavioral biometric data type. The first set of biometric data is transformed into a first biometric token and a user profile is identified based on the first biometric token, wherein the user profile is associated with a subset of content and a payment account identifier of a payment account. Access to the subset of content is provided to the user via the XR system based on the identified user profile. While the user uses the XR system, a transaction request is received that is associated with the subset of content. Based on the transaction request, a second set of biometric data of the user is automatically collected, wherein the second set of biometric data includes biometric data of at least one behavioral biometric data type. The second set of biometric data is transformed into a second biometric token and the association between the second biometric token and the user profile is verified. Based on verifying that the second biometric token is associated with the user profile, a transaction is initiated based on the transaction request, the transaction including the payment account identifier and the second biometric token, whereby a transaction processing entity with which the transaction is initiated is configured to authenticate an identity of the user based on the second biometric token and to cause a transaction amount to be paid from the payment account.

### BRIEF DESCRIPTION OF THE DRAWINGS

The present description will be better understood from the following detailed description read in light of the accompanying drawings, wherein:

FIG. 1 is a block diagram illustrating an extended reality (XR) system enabling processing of transactions using biometrics according to an embodiment;

FIG. 2 is a block diagram illustrating an XR system enabling processing of transactions using biometric tokens according to an embodiment;

FIG. 3 is a block diagram illustrating an XR system enabling processing of transactions using biometrics and grouped user profiles according to an embodiment;

FIG. 4 is a flow chart illustrating a computerized method for providing access to content and processing associated transactions via an XR system according to an embodiment;

FIG. 5 is a flow chart illustrating a computerized method for providing access to content and processing associated transactions via an augmented reality (AR) system according to an embodiment;

FIG. 6 is a flow chart illustrating a computerized method for providing access to content and processing associated transactions via a virtual reality (VR) system according to an embodiment; and

FIG. 7 is a flow chart illustrating a computerized method for guiding a user to content predicted to be of interest to the user based on interest data and historical user data.

FIG. 8 illustrates a computing apparatus according to an embodiment as a functional block diagram.

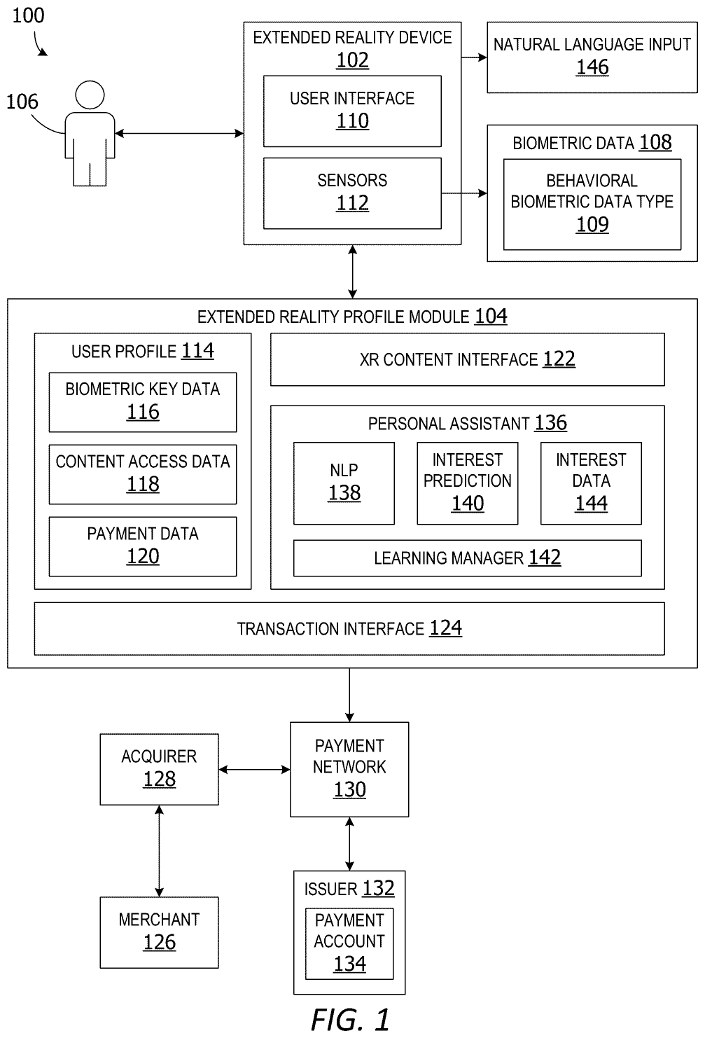

Corresponding reference characters indicate corresponding parts throughout the drawings. In FIGS. 1 to 7, the systems are illustrated as schematic drawings. The drawings may not be to scale.

### DETAILED DESCRIPTION

Aspects of the disclosure provide a computerized method and system for enabling users to use extended reality (XR) systems to access content and initiate transactions based on that content using behavioral biometrics for user identification and authentication. The described method and system automatically capture biometric data of the user as the user uses the XR system and uses the automatically captured biometrics to seamlessly provide the user access to content that is associated with the user's profile and to enable the user to seamlessly initiate and complete transactions from within the XR content/environment (using the automatically captured biometrics for authenticating the user with respect to the transaction). The described systems and methods further apply tokenization techniques to the captured biometric data to both secure the user's biometric information and to enhance the efficiency with which the biometric data is evaluated for identification and authentication purposes. While the user uses the XR system, the captured biometrics are used to match the user to the associated user profile and thereby identify content to which the user should be provided access. The profile further informs the XR system about payment accounts or other payment information that the user can use for transactions. When the user takes an action within the environment of the XR system/content that initiates a transaction, the XR system may automatically capture a fresh set of biometric data that can be used to both re-verify the user's identity within the XR system and authenticate the user with respect to other entities that are involved in facilitating the transaction (e.g., a payment network, issuer, acquirer, or the like).

The disclosure addresses various challenges, such as those associated with providing users seamless and streamlined experiences in XR environments when accessing content therein and when initiating transactions from within the XR environments. The disclosure operates in an unconventional manner at least by leveraging behavioral biometrics of users, which can be captured automatically and in the background while the users use the XR systems (e.g., capturing the users' movement patterns while they interact with provided XR content), to identify users, determine user profiles of users, and to authenticate users when they initiate transactions from within the XR environments. The disclosure provides significant flexibility with respect to the behavioral biometrics used, such that the types of biometrics captured and used can be selected based on the capabilities of the XR system (e.g., VR systems may have different capabilities than AR systems) and on requirements associated with the use of the biometrics (e.g., biometrics used to match a user to a user profile may differ from biometrics used to authenticate the user with respect to transactions). Because the use of behavioral biometrics can occur in the background during the user's use of the system, the user experience associated with accessing XR content and initiating and completing transactions within the XR environment is significantly streamlined. Further, the use of the captured biometric information for multiple purposes as described herein enhances the efficiency of the interaction between the XR system and any transaction processing entities. For instance, the biometric data captured by the XR system for matching the user to a user profile may also be configured to be used by a transaction processing entity when authenticating the user with respect to a transaction, such that matching and authenticating information need only be collected one time, rather than multiple times. Further, the use of the behavioral biometrics for the tasks described herein may enhance the security of the user's information as well as enhancing the security of associated transaction processes using multi-point authentication. For instance, behavioral biometrics may provide multiple points of user authentication and/or be combined with other types of information, such as physical biometrics (e.g., retinal biometrics, facial recognition biometrics), user-provided information such as passwords or personal identification numbers (PINs), or the like.

FIG. 1 is a block diagram illustrating an XR system 100 (e.g., extended reality device 102 and extended reality profile module 104) enabling processing of transactions using biometrics (e.g., biometric data 108 of a user 106) according to an embodiment. In some examples, the user 106 wears and/or interacts with the XR system 100 using the XR device 102 via the user interface 110 of the XR device 102. The XR device 102 communicates and/or interacts with the XR profile module 104 to identify, determine, and/or obtain the XR content to be provided to the user 106 based on a user profile 114 of the XR profile module 104. The XR profile module 104 is further configured to communicate and/or interact with a payment network 130 via a transaction interface 124 to enable the user to initiate and process payments and/or associated transactions via the XR system 100.

In some examples, the XR profile module 104 is stored and/or executed on the XR device 102 itself (e.g., the XR device 102 includes augmented reality (AR) glasses that also include and execute the XR profile module 104 as described herein). Alternatively, or additionally, the XR profile module 104 and/or a subset of components thereof may be stored and/or executed on a separate device of the XR system from the XR device 102 (e.g., the XR device 102 may include a mask and/or other headgear worn by the user to provide virtual reality (VR) content and the XR profile module 104 may be stored and executed on a computing device that is separate from and in communication with the XR device 102, such as a video game console, personal computer, laptop, server device, or the like).

The XR device 102 includes hardware, firmware, and/or software configured to provide XR content to the user 106 (e.g., VR content, AR content, and/or mixed reality (MR) content) via a user interface 110 and to collect data from the user 106, including biometric data 108, via the sensors 112. Further, the XR device 102 is configured to provide biometric data 108 to the XR profile module 104 and to send and/or receive data associated with the XR content being provided to the user 106 (e.g., the XR device 102 receives XR content data to be displayed to the user 106 via the user interface 110 and the XR device 102 sends data indicating the user 106′s input and/or interaction with the XR content that is provided).

The user interface 110 of the XR device 102 is configured to provide XR content to the user 106, who is wearing or otherwise interacting with the XR device 102. In some examples, the XR content provided to the user 106 by the user interface 110 includes displaying visual output to the user 106 in the form of VR content (e.g., a three-dimensional image or environment that can be interacted with by the user 106 in a seemingly real or physical way). Such XR content may also include audio output that corresponds to the displayed visual output (e.g., sound effects and/or music associated with the virtual environment being displayed). Additionally, or alternatively, the XR content provided to the user 106 may include AR content (e.g., computer-generated images superimposed on the user 106's view of the real world, such as with AR-enabled glasses). The user interface 110 of the XR device 102 may include one or more interfaces for displaying or otherwise providing visual output to the user 106 and/or other related interfaces for providing other aspects of the XR content, such as speakers or headphones for providing audio output to the user 106 or contact-based interfaces that enable the system to provide touch-based output to the user 106 (e.g., a glove-based interface that provides touch-based feedback or a controller or other device that provides vibration-based feedback). In other examples, the user interface 110 may include more, fewer, or different combinations of interfaces for providing the XR content to the user 106 without departing from the description herein.

The sensors 112 of the XR device 102 are configured to measure aspects and/or features of the user 106 and/or the user's behavior to collect biometric data 108 that can be used for authentication of the user's identity and/or other purposes as described herein. In some examples, the sensors 112 include motion sensors, retinal scanning sensors, cameras or similar sensors configured to capture body motion, stride, hand gestures, or the like, sensors configured to measure a user's body proportions, such as height, fingerprint sensors, heartrate sensors, etc. The sensors 112 of the XR device 102 may include one or more sensors of various types without departing from the description. Further, the sensors 112 may be configured to collect biometric data 108 from the user 106 at discrete moments during the user's use of the XR device 102 (e.g., when the user 106 dons the XR device 102, when the user selects to view XR content that has limited access), the biometric data 108 may be collected at consistent intervals (e.g., the XR device 102 captures some biometric data point every 30 seconds), and/or the biometric data 108 may be collected constantly or nearly constantly throughout the user's use of the XR device 102 (e.g., gestures and motions of the user may be captured by camera sensors throughout the user's use of the XR device 102 to identify patterns in those gestures and motions that may be indicative of the user's identity at a later point).

The biometric data 108 is data associated with biometrics the user 106, meaning data indicative of body measurements and calculations related to the user's characteristics. In some examples, the biometric data 108 collected by the sensors 112 of the XR device 102 includes data associated with fingerprints and/or palm prints, vein patterns, facial recognition, retina or iris recognition, user gesture patterns, user motion patterns, heart rate, measures of the user's size, shape, or proportions, etc. Further, some or all of the biometric data 108 may include data of one or more behavioral biometric data types 109 (e.g., a speech pattern, a gesture pattern, a motion pattern, a pattern with which a user presses keys (keystroke pattern)), which are indicative of patterns of behavior of the user. Behavioral biometrics may be contrasted with physical biometrics (e.g., height, fingerprints, retinal patterns), which are indicative of physical characteristics of the user. The biometric data 108 captured by the sensors 112 may include one or more types of biometric data, and those types may include any type of biometric data without departing from the description herein.

The XR profile module 104 includes hardware, firmware, and/or software configured to manage user profiles (e.g., user profile 114) of users (e.g., user 106) to control access to XR content via the XR device 102 and to facilitate payments and other transactions as described herein. In some examples, when the user 106 chooses to access XR content that has limited access and/or initiate a transaction using the XR device 102, the XR device 102 may be configured to communicate with the XR profile module 104 to provide biometric data 108 of the user 106. The biometric data 108 is used by the XR profile module 104 to match the user 106 with an associated user profile 114 and/or authenticate the user 106's identity with respect to the user profile 114. While the XR profile module 104 is shown as including only a single user profile 114, in other examples, the XR profile module 104 may store and/or access more or different user profiles without departing from the description.

The user profile 114 is configured to store data associated with the user 106′s use of the XR system 100 and to enable the user 106 to access XR content and make payments using the XR system 100 as described herein. The user profile 114 includes biometric key data 116, content access data 118, and payment data 120.

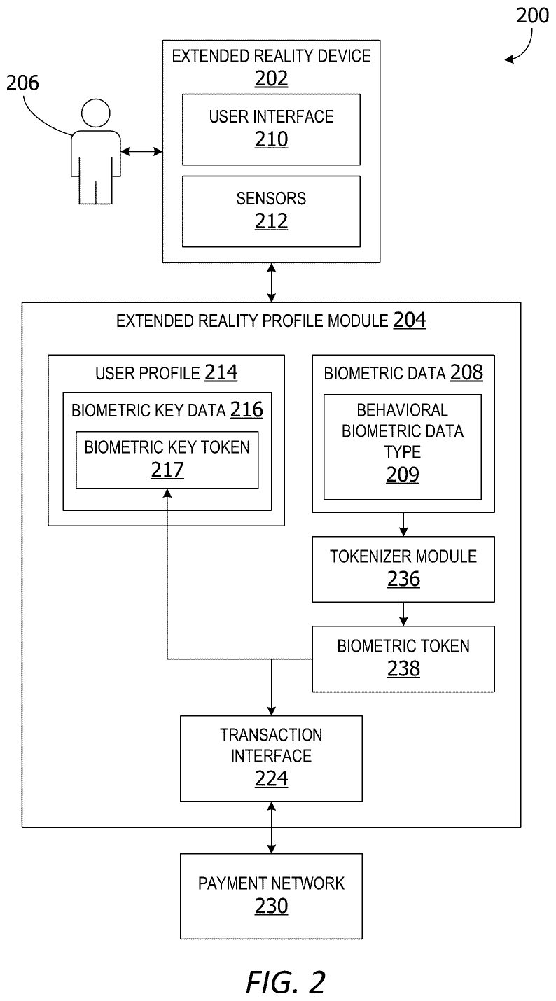

The biometric key data 116 includes biometric data associated with the user 106 that is compared to biometric data 108 received from the XR device 102 to match the user 106 to the user profile 114. In some examples, matching the biometric data 108 to the biometric key data 116 includes matching one or more biometric data values between the two data sets within defined value thresholds (e.g., biometric data associated with a user's gestures may include data values that are within a defined range of values due to the fact that the user's gestures are not perfectly replicated each time). Alternatively, or additionally, a formula or function may be applied to one or more data values of the biometric data 108 and the biometric key data 116 and the results of those applications may be compared to determine whether the biometric data 108 and the biometric key data 116 match (e.g., a hash function may be applied to each of the biometric data 108 and the biometric key data 116 in a consistent manner such that the results can be compared). In other examples, methods such as forming tokens based on the biometric data, as described below with respect to FIG. 2, may be used without departing from the description.

When the biometric data 108 received from the XR device 102 matches the biometric key data 116 of the user profile 114, the identity of the user 106 is confirmed and the XR system 100 is enabled to provide XR content associated with the user profile 114 to the user 106 via the XR device 102. In such cases, the XR content provided to the user 106 is based on the content access data 118. For instance, the content access data 118 may include indications of levels of XR content that are available to the user profile 114 (e.g., a default level of content, an entry level of content, a premium level of content), types of XR content that are available to the user profile 114 (e.g., specific genres of XR content, such as a set of related VR games), and/or specific instances of XR content that are available to the user profile 114 (e.g., a specific AR application). The content access data 118 may be configured to indicate the user's access to a variety of types of XR content and/or levels of granularity of XR content without departing from the description.

Further, matching the biometric data 108 to the biometric key data 116 of the user profile 114 may enable the user 106 to initiate payments or transactions using the payment data 120 of the user profile 114. As a result of the match, the user's identity may be authenticated based on the biometric data 108 and that match may be used when facilitating the transaction via the transaction interface 124. Additionally, or alternatively, the biometric data 108 and/or payment data 120 may be provided to the payment network 130, which may then use that data to perform authentication procedures with respect to the requested transaction. In some examples, the payment data 120 includes an identifier of a financial entity (e.g., a bank or credit card company), a routing number, an account number, identity information associated with the user, or the like.

In some examples, biometric key data 116 of a user profile 114 may be defined and/or otherwise created upon initial creation of the user profile 114 (e.g., when the user 106 first accesses the XR device 102, the user 106 may be prompted to create a user profile 114). Additionally, or alternatively, definition or creation of the biometric key data 116 may be done based on a request by the user 106 (e.g., if the user's profile 114 exists and the user's identity is established, the system may be configured to enable the user 106 to recalibrate, redefine, or otherwise change the biometric key data 116 for future use by the user 106). Defining and/or redefining the biometric key data 116 of a user profile 114 may include the sensors 112 of the XR device 102 capturing biometric data over the course of a defined time period and storing some or all of the captured biometric data as the biometric key data 116 of the user profile 114. The biometric key data 116 may also include variance thresholds or confidence thresholds associated with the biometric data values therein, such that, when biometric data 108 is matched with the biometric key data 116, a match can be identified even if the biometric data 108 and biometric key data 116 do not match exactly but do match within the defined variance or confidence thresholds (e.g., a biometric data value of biometric data 108 is considered to match a corresponding biometric data value of the biometric key data 116 when the values are within a 10% variance threshold of each other).

Additionally, or alternatively, defining biometric key data 116 includes a user selecting to provide a gesture (e.g., a defined hand position and/or movement, such as “give a thumbs up gesture” or “move your hand from left to right”) or body movement (e.g., a step or stride pattern, such as “3 steps forward, 2 steps right”) as part of the biometric key data 116 and then, when prompted by the XR system 100, the user performing the gesture or body movement so that it can be captured by the sensors 112. For instance, user 106 may select to add a hand gesture to the biometric key data 116 of the user profile 114 and the XR device 102 may display a prompt to perform the gesture on the user interface 110. In response to the prompt, the user 106 may perform the desired hand gesture and the hand gesture is captured by the sensors 112.

The XR profile module 104 is further configured to obtain, provide, and/or otherwise interact with XR content via an XR content interface 122. In some examples, the XR content interface 122 includes a network interface that connects the XR profile module 104 to a server or network upon which the available XR content is stored. The XR content interface 122 may be configured to send requests for XR content based on the user 106's use of the XR device 102 and to receive XR content in response to the sent requests. The received XR content may then be forwarded to the XR device 102 and provided to the user 106 via the user interface 110. In some examples, the XR content interface 122 may be used by the XR profile module 104 to access XR content when the biometric data 108 of the user 106 matches a user profile 114 that is configured to have access to the XR content.

In some examples, the XR profile module 104 includes an artificial intelligence (AI) powered personal assistant 136 that utilizes natural language processing (NLP) 138 to analyze natural language input 146 received from the user 106. The natural language input 146 includes sounds, spoken words, and other forms of verbal communications, such as, but not limited to, natural language words spoken by the user.

The NLP 138 analyzes natural human language in the form of verbal communication and/or natural language text, to create, understand, interpret, and manipulate natural language data. The AI personal assistant 136, in other examples, communicates with the user by using the NLP 138 to analyze words spoken by the users voice through natural language processing technology. The AI personal assistant talk to the user and respond based on feedback given by the user via voice, and/or observing behaviors within the XR system to determine interest, likes and dislikes, skills through skill assessments, areas of improvement, career related training or learning content, and navigating to the most desirable outcome

The personal assistant 136, in some examples, includes an interest prediction 140 software module. The interest prediction 140 module is an artificial intelligence (AI) powered module that analyzes natural language data, as well as user behavior data, search data, and other content-related data, to identify a level of user interest in various types of content and/or predict what is likely to be of interest to the user.

The personal assistant 136, in other examples, includes a learning manager 142 software module. The learning manager 142 is an AI powered module that analyzes natural language data, as well as user behavior data, search data, and/or other content-related data, to identify types of educational content that is likely to be of interest to the user.

In some examples, the personal assistant 136 is implemented on a non-XR environment computer system, such as a desktop, laptop and/or mobile device to gather interest data associated with the user. In other examples, the personal assistant 136 is implemented in the XR environment. The personal assistant 136 analyzes biometric data, user behavior data, historical data, dwell time, user profile data, user feedback and other content-related data and user-related data to generate interest data 144.

The historical data is data associated with previous actions, searches, purchases, and other behaviors of the user. The historical data can include purchase history associated with one or more payment accounts, such as credit card payment accounts. The historical data in other examples includes previous search data, historical documents retrieved, historical video viewing history, etc.

In some examples, the historical data is data generated, obtained and/or stored by a payment provider, payment card issuer, electronic wallet issuer, or other payment-related entity, such as, but not limited to, a credit card provider, debit card provider, digital wallet provider, etc. The historical data in these examples includes user purchase history, transaction approval history, declined transaction data, fraud attempts data, and other previous transaction-related data associated with the user and/or a user payment account. The historical data, in these examples, is used to generate the interest data for the user. The interest data, in other examples, enables the system to apply machine learning/pattern recognition to the interest data including the historical data to identify content likely to be of interest to the user for viewing, utilization and/or future purchase.

The user profile is a profile including user data, such as, but not limited to, the user profile 114 in FIG. 1. The user profile data can include, for example, user-provided preference information indicating user likes, dislikes and preferences provided by the user.

The interest data 144 is data associated with content within the XR environment (XR system) and/or content within the non-XR environment. The interest data 144 is data identifying high interest items, low interest items, likes of the user, and dislikes of the user. The interest data 144 is data associated with content, such as, but not limited to, content on websites, educational/training materials, skills assessments, tutorials, purchases, video content, audio (music) content, games, search terms, social media, and/or any other type of content associated with the XR environment and/or the non-XR environment.

The interest prediction 140 analyzes interest data 144 with content data describing an item or portion of content within the XR environment to predict whether the user is likely to find the item or portion of content interesting. The interest prediction 140 optionally analyzes user feedback and other available data with the interest data to predict a level of user interest and/or disinterest in new content. In other words, the interest prediction module determines which content a user is likely to be interested in and which content a user is likely to show a lack of interest (disinterest).

In other examples, the AI powered learning manager 142 guides the user through learning experience options within the XR environment. The learning manager 142 guides the user through learning experience options within the XR systems, via input controllers, analysis of body movements and/or verbal instructions an input communicated to the learning manager 142 and interpreted from the user's voice through natural language processing technology. The learning manager 142 of the AI personal assistant talks to the user and responds based on feedback given by the user via voice, and/or observing behaviors within the XR system to determine interest, likes and dislikes, skills through skill assessments, areas of improvement, career related training or learning content, and navigating to the most desirable outcome.

The learning manager 142, in still other examples, observes behaviors and interest from the user in the XR system via verbal approval or disapproval, scoring within the training or learning simulation, pupil dilation, heart rate, voice inflection, behavioral interest-tracking eye movement throughout the experience, presence in the environment(s) and general content interest from time spent. The AI personal assistant communicate generated interest data associated with the user back to one or more computing devices within the non-XR environment, leveraging its services to help guide and assist the user to appropriate training and educational content on the XR platform and/or one or more non-XR platforms. The learning manager 142 optionally also compiles credit for the training/learning in designated Learning Management Systems if applicable.

In some non-limiting examples, information gathered by the interest prediction 140 and/or the learning manager 142 from the XR environment are utilized within the XR environment to fine-tune the interest predictions and/or the learning recommendations made by the personal assistant 136. In other examples, the personal assistant 136 operating in a non-XR environment is able to transfer the personal assistant 136 capabilities into one or more other XR environments or platforms. The AI powered personal assistant guides the user through experiences, shopping, and entertainment options within the XR systems, being communicated with by the users voice through natural language processing technology. The AI personal assistant communicates with the user using natural language speech recognition and responds to user inquiries and commands based on feedback given by the user via voice, and/or observing behaviors within the XR system to determine interest, likes and dislikes, and navigating to the most desirable outcome.

In some examples, the AI powered personal assistant 136 observes behaviors and interest from the user in the XR system via verbal approval or disapproval, pupil dilation, heart rate, voice inflection, and behavioral interest. Behavior interest is determined based on body movements, such as, but not limited to, tracking eye movement throughout the experience, direction of gaze, head movement, dwell time, length of presence in the environment(s) and general content interest determined based on time spent viewing and/or interacting with various types of content. The AI personal assistant communicates analysis results (what it learned) back to the non-XR environment. The computer system(s) in the non-XR environment optionally leverage the analysis results, including interest data generation, interest predictions and/or recommendations services to help guide and assist the user on non-XR platforms, as well.

The XR profile module 104 is further configured to initiate and/or otherwise facilitate transactions and payments associated with the user 106′s use of the XR device 102 via the transaction interface 124. In some examples, the transaction interface 124 includes a network connection to a payment network 130 and/or other transaction processing entity (e.g., an acquirer, 128, an issuer 132, or the like). Further, the transaction interface 124 may be defined or otherwise configured based on a transaction processing specification that enables efficient, effective interfacing between the XR system 100 and the payment network 130 (e.g., the EMV Secure Remote Commerce (SRC) Specification, MASTERCARD “Click to Pay”). The XR profile module 104 may be configured to receive a transaction request from the XR device 102 or otherwise based on the user 106′s interactions with the XR device 102 and, as a result of the transaction request, the XR profile module 104 may initiate or otherwise facilitate the requested transaction via the transaction interface 124 through communications with the payment network 130. The biometric data 108 may be used in combination with payment data 120 of the user 106's user profile 114 in initiating or otherwise facilitating the transaction (e.g., the biometric data 108 is used to authenticate the user's identity with respect to the payment network 130, issuer 132, and an associated payment account 134). In some examples, the biometric data 108 is used to authenticate the user's identity within the XR system and an indicator the authentication is provided to the payment network 130 or other transaction processing entity, such that the security of the user's biometric data is secured within the XR system at all times. Alternatively, secured versions of the biometric data (e.g., biometric token data as described below) may be provided to a transaction processing entity when requesting transactions to enable that entity to authenticate the user's identity (e.g., some transaction processing entities may require such processes to authenticate the user). For instance, a biometric key based on the biometric data 108 may be passed to the transaction processing entity and the transaction processing entity may be configured to compare the biometric key to a previously-registered biometric key in order to authenticate the user's identity. Additionally, or alternatively, regardless of whether the biometric data 108 is passed to the transaction processing entity or an indication of the authentication of the user's identity is passed to the transaction processing entity in another manner, the payment information and/or transaction information (e.g., the payment data 120 such as account information, information about the good or service being purchased, etc.) may be sent to the transaction processing entity in order to facilitate the transaction as described herein.

The XR profile module 104 is configured to enable transactions and/or payments to be facilitated between a payment account 134 of the user 106 and a merchant 126 based on the user's use of the XR system 100. The XR profile module 104 is configured to communicate with the payment network 130, which is configured to communicate with the issuer 132 that manages the user's payment account 134 and the acquirer 128, which manages an account of the merchant 126. The transaction may be processed to transfer funds from the user's payment account 134 to the merchant 126 in any manner without departing from the description herein.

In some examples, when the AI personal assistant 136 guides the user to an experience that requires payment, the behavioral biometric authentication system validates the user and grants or denies access to a payment method and account based on predetermined combination(s) of static biometrics and behavioral biometric markers for authorized users on that account. In some cases, additional verification of the user may be requested or required prior to granting access to the payment method.

Thus, in some cases, a successful, frictionless transaction is approved without additional verification using the behavioral biometric authentication. In other examples, additional verification is required for additional confirmation. For example, a user can be sent a one-time code via email, text message, or other mobile user device (mobile phone) push notification to confirm the identification of the user making the payment. This additional verification can optionally occur via a companion application on the mobile phone/mobile user device.

The additional verification may be required, for example, where one or more of the biometric tokens does not match with a stored token. In another example, the additional verification may be required where the user has requested additional verification under pre-defined conditions.

Once authentication is established, the user can purchase experiences or items. In this manner, the system facilitates payments in XR systems through behavioral biometric authentication, AI learning personal assistant, natural language processing and the learning manager.

FIG. 2 is a block diagram illustrating a system 200 configured as an extended reality system enabling processing of transactions using biometric tokens (e.g., biometric token 238) according to an embodiment. In some examples, the system 200 and associated components (e.g., the XR device 202, the XR profile module 204) is configured in substantially the same manner as system 100 of FIG. 1 described above. The system 200 includes an XR device 202 and an XR profile module 204 that may be used by a user 206 to view or otherwise consume XR content and/or initiate transactions as described above with respect to XR device 102 and XR profile module 104 of FIG. 1. Further, the XR profile module 204 includes a tokenizer module 236 that is configured for generating biometric tokens 238 from the biometric data 208 that is collected by the sensors 212 of the XR device 202 and provided to the XR profile module 204. The generated biometric tokens 238 may be used for comparison to other tokens (e.g., the biometric key token 217 of the biometric key data 216 of the user profile 214) to authenticate or otherwise verify the identity of the user 206. Use of a biometric token 238 for such comparisons may be beneficial in that the biometric tokens may occupy significantly less memory space than the raw biometric data 208, the process of comparing two tokens may be performed more efficiently than comparison of a multiple different types of raw biometric data, and biometric data that may be sensitive is secured and protected through the transformation into a biometric token 238, such that the token can be shared over network connections or the like without exposing the user 206's sensitive biometric data to possible interception by another party.

In some examples, the biometric data gathered from the user 206 and/or the associated biometric key data 216 may be stored and/or processed in a separate portion of the XR device 202 and/or the XR profile module 204, such as a secure hardware chip that is separate from other chips of the associated device. This separation provides enhanced security for protecting the user's biometric data while still enabling the user to be authenticated using the biometric data.

In other examples, the biometric data is stored and/or processed at the payment network level rather than at the device level. This biometric processing can also alternatively include the additional verification of the user after the behavioral biometric authentication.

For instance, the user's biometric key data may be stored on a secure, separate data store in the device associated with the XR profile module 204 in a tokenized form (e.g., the biometric key token 217). When the user's identity is authenticated within the system using biometric data, the user's biometric data may be compared to the tokenized biometric key data on a secure, separate hardware chip, such that the authentication process is insulated from other processes being performed on the system. Upon completion of the authentication in the secure section of the system, an indicator of the authentication result may be provided to indicate whether or the authentication was successful or not, and the system may then perform additional processes based on that indicator. For instance, upon a successful authentication indicator being provided by the secure section of the system, the system may then provide the user's payment data and an indicator of the authentication of the user to the payment network to facilitate a transaction using the payment data.

In some examples, the tokenizer module 236 includes hardware, firmware, and/or software configured to generate a biometric token 238 based on a received set of biometric data 208. The tokenization process performed by the tokenizer module 236 may include evaluating equations or formulas that take one or more aspects of the biometric data 208 as input and produce some or all the biometric token 238 as output. The process used to tokenize the biometric data 208 may be based on the behavioral biometric data type 209 of the biometric data 208 (e.g., a different process may be used when tokenizing biometric data associated with the user's walking gait than the process used when tokenizing biometric data associated with the user's retinal scan). It should be understood any tokenization process that transforms the biometric data 208 of the user 206 into a biometric token 238 may be used by the tokenizer module 236 without departing from the description herein.

Further, the user profile 214 is configured to store a biometric key token 217, which is a result of performing the tokenization process of the tokenizer module 236 on the biometric key data 216 of the user profile 214. The tokenizer module 236 may be used to generate the biometric key token 217 when the user 206 is defining or redefining the biometric key data 216 of the user's user profile 214. Because the biometric key token 217 and the biometric token 238 based on the captured biometric data 208 are tokenized using the same process, they may be directly compared to determine whether the current user of the XR device 202 matches a user profile 214 of the XR profile module 204 and, thereby, determine what XR content the user 206 has access to and whether the user 206 can initiate transactions using payment data of the user profile 214.

The biometric token 238 may also be provided to the payment network 230 via the transaction interface 224 to enable the XR profile module 204 and payment network 230 to initiate and facilitate transactions as described herein. The biometric token 238 may be evaluated at the payment network 230 to authenticate or otherwise verify the identity of the user 206. The payment network 230 may store a token for comparison to a received biometric token 238 as described with respect to the biometric key token 217. Alternatively, or additionally, other methods of evaluating the biometric token 238 may be used. Further, it should be understood that such communication for initiating and/or facilitating transactions may include the passing of payment information, such as an account number or other account information and/or other transaction details, to the payment network 230 via the transaction interface 224 in any manner without departing from the description.

In alternative examples, the biometric token 238 may be used to authenticate the user's identity with in the XR profile module 204 and an indicator of the result of that authentication may be provided to the payment network 230 instead of the biometric token 238 itself, such that the security of the user's biometric data is enhanced because the user's biometric data is preserved on the XR system rather than being sent to other entities such as the payment network 230. In such examples, the authentication process of the XR profile module 204 is configured in such a way that the payment network 230 trusts the results of the authentication process sufficiently to accept an indicator of the result of the authentication as sufficient to authenticate the user's identity for an associated transaction.

In some examples, the tokenizer module 236 is configured to generate different types of biometric tokens 238 for different purposes. For instance, the tokenizer module 236 may be configured to generate a first type of biometric token 238 for use with the user profile 214 within the XR profile module 204 and to generate a second type of biometric token 238 for provision to the payment network 230 in association with the facilitation of transactions (e.g., the payment network 230 may define requirements or preferences about how the token 238 is generated). Alternatively, or additionally, the XR profile module 204 may be configured to include multiple tokenizer modules 236 with at least one module for each type of token that the system is configured to generate.

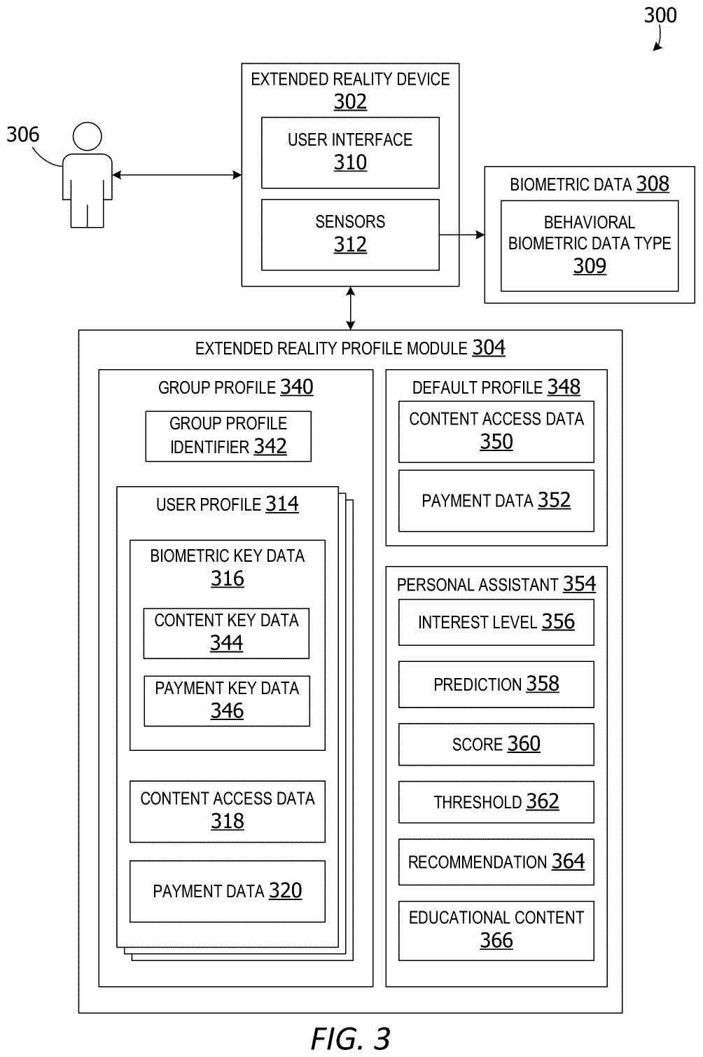

FIG. 3 is a block diagram illustrating a system configured as an extended reality system enabling processing of transactions using biometrics and grouped user profiles according to an embodiment. In some examples, the system 300 and associated components (e.g., the XR device 302, the XR profile module 304) is configured in substantially the same manner as systems 100 and/or 200 of FIGS. 1 and/or 2, respectively, described above. The system 300 includes the XR device 302 and XR profile module 304 that are configured to enable the user 306 to access XR content and initiate transactions based on a hierarchy of profiles (e.g., the user profiles 314 of the group profile 340) and through more granular use of different sets of biometric data (e.g., different biometrics required for content key data 344 and payment key data 346).

In some examples, the XR system 300 is configured to be used by multiple different users within a defined user group (e.g., a family of users in a household, a group of coworkers on a team). In these examples, the payment account can be a shared payment account across the multiple users on the system. The XR profile module 304 is configured to store or otherwise organize the user profiles 314 in association with a group profile 340 which may be identified using a group profile identifier 342. Each user 306 associated with a user profile 314 within the group profile 340 may be use the XR device 302 with their personal user profile 314 as described herein.

When a user 306 begins to use the XR system 300, such as by signing on to the system 300 via the XR device 302, the process of initially accessing the user's user profile 314 may include providing the group profile identifier 342 or associated data to the system 300 (e.g., the user 306 may provide the group profile identifier 342 via the user interface 310 or the group profile identifier 342 may be determined based on other data, such as a location of the device 302, a network to which the system 300 is connected, or the like). When the group profile identifier 342 is identified to the XR profile module 304, the profile module 304 may use the group profile identifier 342 in addition to the biometric data 308 to identify the user profile 314 of the user 306 (e.g., the profile module 304 may narrow down a search to identify a user's profile 314 based on the group profile identifier 342).

In some examples, the group profile 340 includes profile settings or attributes that apply to the associated user profiles 314 by default and/or that are enforced as requirements of the associated user profiles 314. For instance, a group profile 340 may define the set of biometric data types (e.g., behavioral biometric data type 309) that are required for use in the biometric key data 316 of the associated user profiles 314. Such requirements may be minimum requirements (e.g., a user profile 314 may use additional biometric data types so long as the required biometric data types are included in the biometric key data 316). Additionally, or alternatively, the group profile 340 may define default sets of biometric data types that are used in biometric key data 316 in user profiles 314 associated with that group profile 340. In such cases, biometric data types of biometric key data 316 of user profiles 314 may be changed by the users 306 to include more, fewer, or different types of biometric data from the defined default sets.

Further, the group profile 340 may include other default settings or requirements associated with the content access data 318 and/or the payment data 320 of the user profiles 314 associated with the group profile 340. For instance, a group profile 340 may define a base level of content in the content access data 318 and/or payment data 320 associated with a group payment account that are accessible by all user profiles 314 associated with the group profile 340. For instance, a group profile 340 associated with a household may include user profiles 314 for each member of the household that include content access to defined content package and a shared payment account when using the system 300.

Additionally, or alternatively, the content access data 318 and/or payment data 320 of each user profile 314 in a group profile 340 may be defined differently from other user profiles 314 in the group profile 340. For instance, the content accessible by each user profile 314 may be defined to include different subsets of content (e.g., in a household, a parent may define a child's user profile 314 to include access to content that is appropriate for children and to limit access to content that may not be appropriate for children). Such differences may also be defined in the payment data 320 of the user profile 314 (e.g., a parent may define a child's user profile 314 to have access to a payment account with limited funds and/or monitoring instead of a less limited payment account to which the parent's account may have access).

In some examples, the biometric key data 316 of the user profiles 314 of the XR profile module 304 include separate key data for content (e.g., content key data 344) and payments (e.g., payment key data 346). For instance, the content key data 344 may require a first set of biometric data types that include three types of data values and the payment key data 346 may require a second set of biometric data types that included four types of data values. In such examples, the payment key data 346 may require the same biometric data as the content key data 344 and at least one additional biometric data value to further secure access to the payment data 320 of the user profile 314.

For instance, a user may access a VR game on the system 300 based on the user's profile 314 having access to the game. The system matches the user's biometric data 308 to the content key data 344 of the user's profile 314 based on, for instance, the user's height, the user's gait, and the user's retina. During use of the VR game, when the user attempts to make an associated purchase with the payment account associated with the user profile 314, the system matches the user's biometric data 308 to the payment key data 346 of the user profile 314 based on, for instance, the user's height, the user's gait, the user's retina, and a hand gesture made by the user when selecting to initiate the purchase. As a result, the use of the payment data 320 of the user profile 314 requires more biometric data matching than just accessing the content based on the content access data 318. In other examples, the content key data 344 and the payment key data 346 may include more, fewer, or different types of biometric data, including overlapping and/or non-overlapping biometric data types between the content key data 344 and the payment key data 346, without departing from the description herein. Further, it should be understood that the quantity and types of biometric data collected and used by the described system may be based on and/or limited by features, capabilities, and/or limitations of the interfaces, sensors, and/or other aspects of the system. For instance, the system may include gloves that the user 306 can wear that include fingerprint sensors and the biometric data 308 collected from the user 306 may include fingerprint biometric data. Alternatively, in systems that do not include such fingerprint sensors, the biometric data collected and used is of other types, as these systems do not have the capability to collect fingerprint biometric data.

Additionally, or alternatively, in some examples, the comparison between biometric data and biometric key data also includes a comparison of other aspects, characteristics, settings, or configuration details of the device and/or system components being used. For instance, such a comparison may include comparing a stored operating system (OS) version of the system to a currently detected OS version. If the biometrics and the configuration details of the device do not match, the comparison may be treated as if the user is not authenticated or otherwise verified as described herein. Other configuration details may include various settings of the XR system, identification information of the hardware of the XR system, sensor types, media access control (MAC) addresses of hardware of the system, and/or other types of configuration details.

The XR profile module 304 further includes a default profile 348 that includes content access data 350 and payment data 352 and is configured for use by users of the system 300 that do not have defined user profiles 314 or that are otherwise unable to sign in to their user profiles 314. When a user 306 accesses the XR device 302 without an associated user profile 314, the system 300 may direct the user 306 to the default profile 348 and provide access to content as defined by the content access data 350 of the default profile 348. In some examples, the default profile 348 also provides the user 306 access to payment data 352 of the default profile 348, though, in many cases, the default profile 348 may have payments disabled (e.g., a user without a user profile may not be allowed to initiate a transaction by the system 300 without providing payment information).

In some examples, the XR reality module 304 includes a personal assistant 354. The personal assistant 354 is an AI powered personal assistant module, such as, but not limited to, the personal assistant 136 in FIG. 1, shown above. The personal assistant 354 generates interest data associated with the user using the XR system. The interest data, in some examples, includes a prediction 358 indicating an interest level 356 associated with a portion of content being presented/displayed to the user or available for presentation/display to the user. The prediction 358 can include a score 360 scoring the level of interest predicted for the user based on the type of content and the user interest data. The score 360 can be implemented using any type of scoring system. For example, but without limitation, the score 360 can be a score of 1 to 10 or any other scoring denominations, wherein the higher score indicates a higher predicted interest in the content However, the examples are not limited to this type of scoring. In other examples, a higher score can indicate less interest in the content or greater disinterest by the user.

In other examples, the personal assistant 354 guides the user to at least a portion of the content associated with educational content predicted to be of interest to the user. The educational content can include task instructions, instructional video, educational video content, educational audio content, text associated with a topic predicted to be of interest to the user, assessment test(s), etc.

In still other examples, the personal assistant 354 analyzes natural language input from the user, by a natural language processor (NLP) module to identify user feedback. The personal assistant generates interest data associated with the of the user using the XR system based on the user feedback and the biometric data. The interest data indicates a level of user interest associated with the subset of content. The personal assistant identifies at least a portion of content having educational content predicted to be of interest to the user.

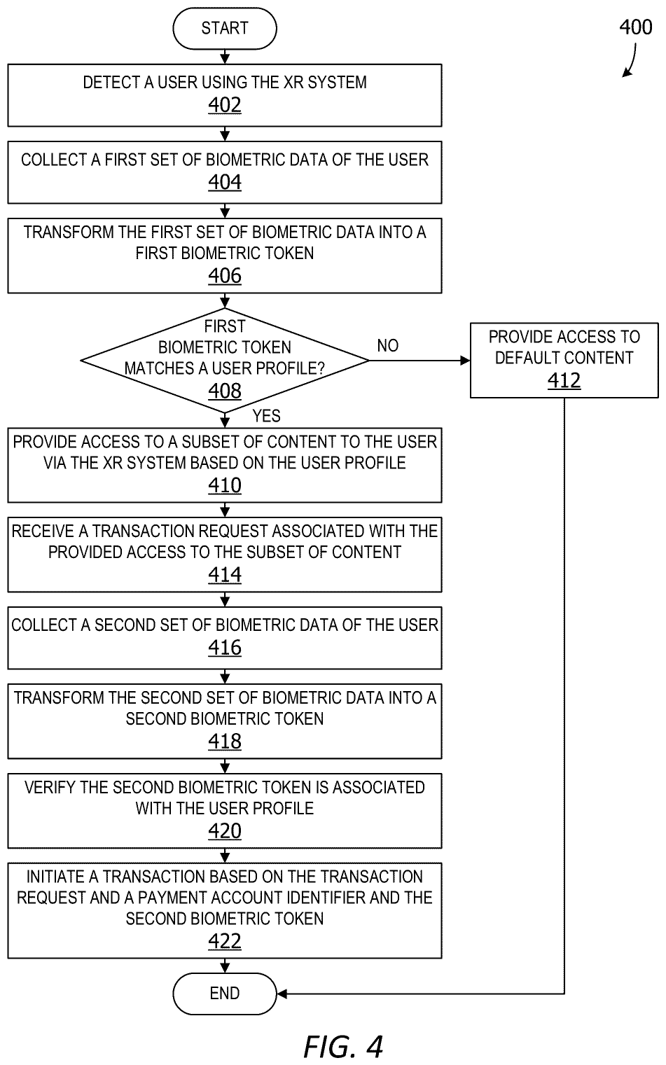

FIG. 4 is a flow chart illustrating a computerized method 400 for providing access to content and processing associated transactions via an XR system according to an embodiment. In some examples, the computerized method 400 is executed or otherwise performed on a component or components of a system such as systems 100, 200, or 300 in FIGS. 1, 2, and 3, respectively. At 402, a user (e.g., user 106) is detected using the XR system (e.g., XR system 100). In some examples, detecting a user of an XR system includes receiving input to an XR device (e.g., XR device 102) of the XR system via a user interface (e.g., user interface 110), such as the pressing of a button or touching of a touch screen. Alternatively, or additionally, sensors (e.g., sensors 112) of the XR system may capture sensor data that indicates a user using the XR system (e.g., motion sensors may detect motion of the XR device).

At 404, a first set of biometric data of the user is collected. In some examples, the collection of the biometric data is based on sensors of the XR system (e.g., motion sensors collecting data indicative of the user's movement patterns, retina sensors capturing data retinal data of the user, a microphone capturing speech or other sounds made by the user). Further, collecting the first set of biometric data may include collecting passive or inadvertent biometric data from the user (e.g., data that may be captured without specific interaction by the user with the system, such as retinal data, fingerprint data, facial recognition data, or certain motion pattern data, such as a user's typical walking gait pattern) and/or collecting active biometric data (e.g., data that is captured by prompting the user to do something or interact with the system in some way, such as prompting the user to say a passphrase or prompting the user to perform a particular gesture). It should be understood that, in some examples, the first set of biometric data includes only a single type or instance of biometric data (e.g., only a retinal scan of the user's eye). Alternatively, the first set of biometric data may include multiple types and/or instances of biometric data as described herein. Additionally, when collecting the first set of biometric data, the system may also collect other types of data, such as a username or login information of the user. In some examples, the first set of biometric data includes at least one type of behavioral biometric data which are associated with specific activities that may be done by the user, such as keystroke patterns when the user is typing, head movement patterns, gait patterns when the user is walking, user height and/or other measurements determined based on user movement patterns, and/or gesture patterns when the user is moving their body generally, their arms, their hands, or other portions of their body.

At 406, the first set of biometric data is transformed into a first biometric token. In some examples, the transformation of the first set of biometric data into a token includes application of formulas or other processes to the various data values of the first set of biometric data to form the biometric token. Any method of tokenization may be used without departing from the description herein. It should be understood that each data value of the first set of biometric data may be associated with a biometric data type (e.g., a behavioral biometric data type 109) and that the associated biometric data type may be used by the system to determine how to include the associated data values in the transformation process (e.g., the transformation process may be configured to tokenize all data values associated with the user's gesture patterns in a particular way, while data values associated with the user's determined height may be transformed in a different way).

At 408, if the first biometric token matches a user profile of the XR system (e.g., a user profile 114 of the XR profile module 104), the process proceeds to 410, where access to a subset of content is provided to the user via the XR system based on the user profile. Alternatively, if the first biometric token does not match a user profile of the XR system, the process proceeds to 412, where access to a default set of content is provided to the user. In some examples, each user profile of the system includes biometric key data (e.g., biometric key data 116) that includes a biometric key token (e.g., biometric key token 217) that is used to match the biometric tokens that are based on biometric data from users of the system. The matching process includes comparing the biometric key tokens of the user profiles to the biometric token associated with the current user and determining whether the biometric token matches a biometric key token of a user profile within a defined confidence interval or threshold (e.g., if a biometric token value differs less than 10% from a biometric key value of a user profile, that may be considered a match). In other examples, other methods of matching a biometric token with a user profile and/or associated biometric key data without departing from the description herein.

At 410, access to a subset of XR content is provided to the user via the XR system based on the user profile (e.g., based on the content access data 118 of the user profile 114). In some examples, providing access includes enabling the user of the system to choose from one or more types of content or specific instances of content and/or displaying the content to the user via a user interface of the XR system (e.g., the user interface 110 of the XR device 102). For instance, in examples where the XR system is a VR system, the user may be provided with one or more different virtual environments or similar applications to choose from and, upon choosing one of the virtual environments, the system may display the virtual environment for the user and enable the user to interact with the virtual environment. Other XR content may include VR games or other applications, AR applications that enable the user to view information about objects they see, view directions regarding a destination, or the like. In some XR content, the user may be enabled to view products and/or services that are for sale in association with the XR content (e.g., downloadable content (DLC) for a VR game) and/or the XR content may be configured to specifically enable the user to purchase products and/or services (e.g., an AR application that provides the user purchase information of a product they are looking at in a store, a VR application that provides the user with a virtual shopping environment through which they can view products and/or services and select to purchase them). At any point during the provision of the subset of content to the user, the process may proceed to 414 when a transaction request is received from the user.

At 412, instead of providing access to a subset of content based on a user profile, no user profile was identified and, as a result, access to a set of default content is provided to the user. The default content may include content that demonstrates the capabilities of the XR system (e.g., access to an initial portion of a virtual game, demonstrations of the types of data that may be provided via an AR interface) and/or enable the user to create a new user profile and, during the profile creation process, define the types of XR content to which the user profile will have access. Such default content may be used by a new owner of an XR system during setup of the XR system and/or as a demonstration for use in a store that sells the XR system so that potential buyers may experience the possible content and functionality of the system.

At 414, a transaction request is received that is associated with the provided access to the subset of content. In some examples, the transaction request is initiated by the user of the XR system via the user interface of the XR system and based on a portion of the XR content that is being provided to the user (e.g., the user selects DLC of a virtual game they want to purchase or the user selects a product they want to purchase based on AR content that is displayed to them when looking at the product at a store). Additionally, or alternatively, the received transaction request may be initiated based on the user responding to a prompt by which the user agrees to make the purchase or the user may select the content to be purchased within the interface of the XR system, such that the transaction request is automatically initiated without further interaction from the user.

At 416, a second set of biometric data of the user is collected. In some examples, the second set of biometric data includes some or all of the same types of biometric data as collected for the first set of biometric data described above. Additionally, or alternatively, the second set of biometric data may include more and/or different types of biometric data from those collected for the first set of biometric data. Collecting the second set of biometric data may be based on the received transaction request as a form of enhanced security associated with enabling the user to initiate transactions using the XR system (e.g., the identity of the user is reconfirmed when they try to purchase something, in addition to the identification performed with respect to the first set of biometric data and the associated matching to the user profile). In addition to providing a second check on the user's identity, the security of the transaction process as described may be further enhanced by enabling the system to require and collect different and/or additional types of biometric data, including different or additional types of behavioral biometric data, when verifying the user's identity with respect to a requested transaction.

At 418, the second set of biometric data is transformed into a second biometric token. In some examples, the same transformation process, or tokenization process, as was used to transform the first set of biometric data into the first biometric token is used to transform the second set of biometric data into the second biometric token. Alternatively, in other examples, any other transformation or tokenization process may be used without departing from the description herein. Further, the transformation process used on the second set of biometric data may be associated with a transaction processing entity (e.g., the payment network 130) with which the transaction will be initiated. For instance, the transaction processing entity may define a method that is to be used by the XR system such that biometric tokens stored by the transaction processing entity for the purpose of authenticating users' identities are consistently derived from the same transformation or tokenization process.

At 420, the association of the second biometric token to the user profile is verified. In some examples, the verification process includes comparing the second biometric token to biometric key data of the user profile (e.g., the payment key data 346 of the biometric key data 316). If this verification is successful, the process proceeds to 422, but if the verification fails, the XR system may prompt the user that the requested transaction cannot be performed. The user may be prompted to try again and/or the second set of biometric data may be recollected at 416, such that a second attempt at verifying the user's identity may be made in the event that the failure of the first attempt was a result of a temporary issue, such as some of the second set of biometric data that was initially collected including outlier data values. Additionally, or alternatively, as a result of one or more failed verification attempts, the XR system may stop providing the user the XR content that is associated with the user profile and divert the user to the default content described above with respect to 412, such that the user is forced to sign on to their user profile again.

At 422, a transaction is initiated that is based on the transaction request, a payment account identifier associated with the user profile (e.g., the payment data 120), and the second biometric token. In some examples, the initiation of the transaction includes sending the payment account identifier, the second biometric token, and/or other transaction request data (e.g., a type of product being purchased, a purchase price of the product, etc.) to a transaction processing entity, such as a payment network, to initiate the transaction. Further, the transaction processing entity may be configured to use the second biometric token, alone or in combination with other data provided by the XR system, to authenticate or otherwise verify the identity of the user for the purpose of facilitating the requested transaction with other entities associated with the transaction (e.g., a transaction process involving a merchant that is selling the product, an acquirer that manages the merchant's account, a payment network, and an issuer that manages the user's payment account (e.g., payment account 134) may be initiated, facilitated, and/or completed based on the data provided to the payment network from the XR system, including the second biometric token).

Additionally, or alternatively, the verification of the second biometric token at 420 may include additional authentication of the user's identity and the generation of an indicator of the result of that authentication for use in facilitating a transaction. The additional authentication may be performed using email, short message service (SMS), push notification or other secondary authentication in addition to the behavioral biometric authentication. In such examples, the second biometric token is not provided to the transaction processing entity and, instead, the indicator of the result of the local authentication process is provided as proof of the authentication of the user's identity, such that the transaction processing entity is enabled to facilitate the transaction as described herein. In such examples, it should be understood that payment information such as the payment account identifier and/or other transaction details may be sent to the transaction processing entity to facilitate the transaction as described herein without departing from the description.

In some examples, the method 400 may be performed whenever a user uses the XR system and it may be performed for multiple different users (e.g., if a second user is detected using the XR system after the first user, the method 400 may be performed to identify a user profile of the second user and enable the second user to access content and initiate transactions based on that user profile as described herein). Alternatively, or additionally, if the XR system is configured to enable multiple users simultaneously (e.g., a VR system that enables multiple users to interact in a single VR environment), the method 400 may be performed for the multiple users simultaneously, such that each user may be enabled to access content and initiate transactions based on separate user profiles and/or content that may be accessible to the multiple users based on a defined group profile (e.g., group profile 340).

Additionally, in some examples, after the transaction is initiated at 422, the transaction may be completed, and the user may return to using or otherwise consuming the subset of content as described with respect to 410. Alternatively, the user may end their session with the XR system and log off or otherwise stop using the system.

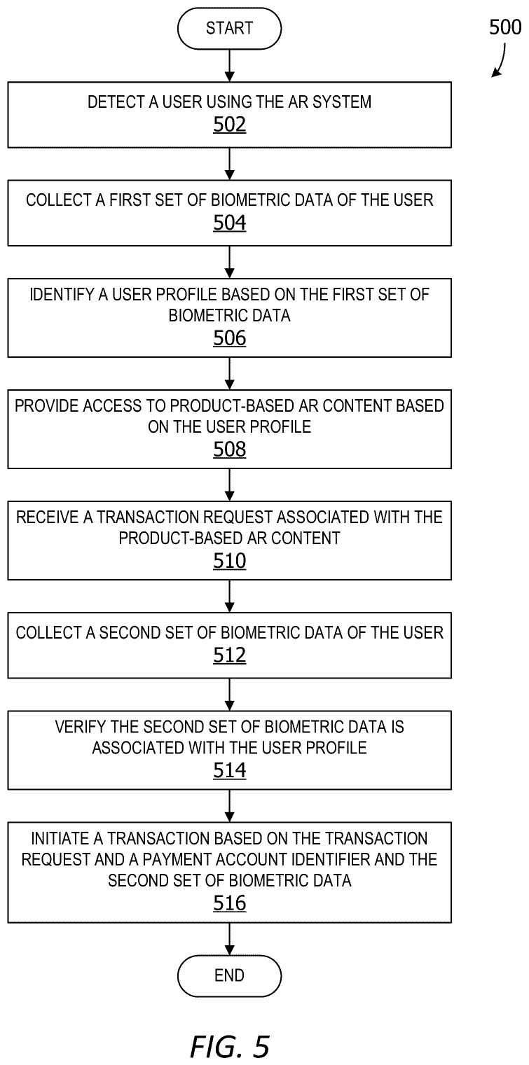

FIG. 5 is a flow chart illustrating a computerized method 500 for providing access to content and processing associated transactions via an augmented reality (AR) system according to an embodiment. In some examples, the computerized method 500 is executed or otherwise performed on a component or components of a system such as systems 100, 200, or 300 in FIGS. 1, 2, and 3, respectively. Additionally, in some examples, portions of the method 500 are performed in substantially the same manner as method 400 described above. At 502, a user using the AR system is detected. The AR system may provide information, pictures, or other displayed input to a user that is overlaid on the user's vision of the real world. In some examples, the AR system includes a device such as glasses which are worn by the user that are configured to display information in the user's view that is associated with, for instance, a product at which the user is looking or a destination to which the user is traveling. Other uses of AR systems include functionality that enables a user to visualize how a piece of furniture may fit in a room, an overlay that guides users on a walking tour through a city, park, or the like, and/or an app that enables a user to point a smartphone at a building and receiving a variety of relevant information via an AR interface, such as companies that are located in the building, associated contact info, or the like. The AR system may further be configured to collect data about the field of the user's vision (e.g., a camera that captures video data of the user's field of vision), the location of the user (e.g., global positional system (GPS) technology, cellular triangulation technology), and/or other data that can be used by the AR system when providing overlaid information to the user. Detection of the user using the AR system may include detecting the user pressing a button or otherwise interacting with an interface of the AR system, detecting movement of the user based on sensors of the AR system, or the like.

At 504, a first set of biometric data of the user is collected via the AR system. In some examples, the collection of biometric data of the user may be performed in substantially the same manner as described herein with respect to method 400 described above. Further, the type(s) of biometric data collected by the AR system may be selected based on specific aspects of an AR system. For instance, an AR system may operate differently with respect to capturing facial recognition data or retinal data of the user as compared to other XR systems (e.g., VR systems that include different goggle devices that capture such data in different ways or capture different specific types of such data), so the biometric data collected from the user by the AR system may differ from other XR system based on such differences. Additionally, or alternatively, the collected biometric data may be focused on head motion and/or gait data that is based on the user of the AR system walking around in a natural way through a real environment.

At 506, a user profile is identified based on the first set of biometric data and, at 508, access to product-based AR content is provided to the user based on the identified user profile. In some examples, the product-based AR content includes overlaid price information, sale information, price comparison information, or the like when the user of the AR system looks at a particular product in a store. The product-based AR content may be in the form of a company-specific app to which the user has obtained access (e.g., the user may have signed up for access with their user profile identifier (e.g., a username or email address).

At 510, a transaction request associated with the product-based AR content is received and, because of the transaction request, the AR system collects a second set of biometric data of the user at 512. In some examples, the AR system requires the user to perform one or more defined behaviors to indicate that they want to purchase the product that it is in the user's field of vision. For instance, the user may be required to make a hand gesture in view of the AR system's camera sensors or to make a head movement, such as a nod, in response to a prompt that is displayed. Alternatively, or additionally, the user may be prompted to interact with an interface of the AR system (e.g., the user is prompted to press a button on the side of the AR glasses). The second set of biometric data may include motion data or other data collected when the user performs gestures or head motions as well, such that the request for the transaction and the collection of the second set of biometric data of the user may be combined with respect to interactions between the user and the AR system.

At 514, the association between the second set of biometric data and the user profile is verified (e.g., through a comparison of the second set of biometric data and biometric key data of the user profile). Based on a successful verification, at 516, a transaction based on the transaction request is initiated, including the use of a payment account identifier and the second set of biometric data for authenticating the user's identity with respect to the transaction. In some examples, the verification of the association between the second set of biometric data and the user profile and the initiation of the requested transaction are performed in substantially the same way as described above with respect to 420 and 422 of method 400. Further, in some examples, the method 500 includes the transformation of biometric data into biometric tokens as described herein.

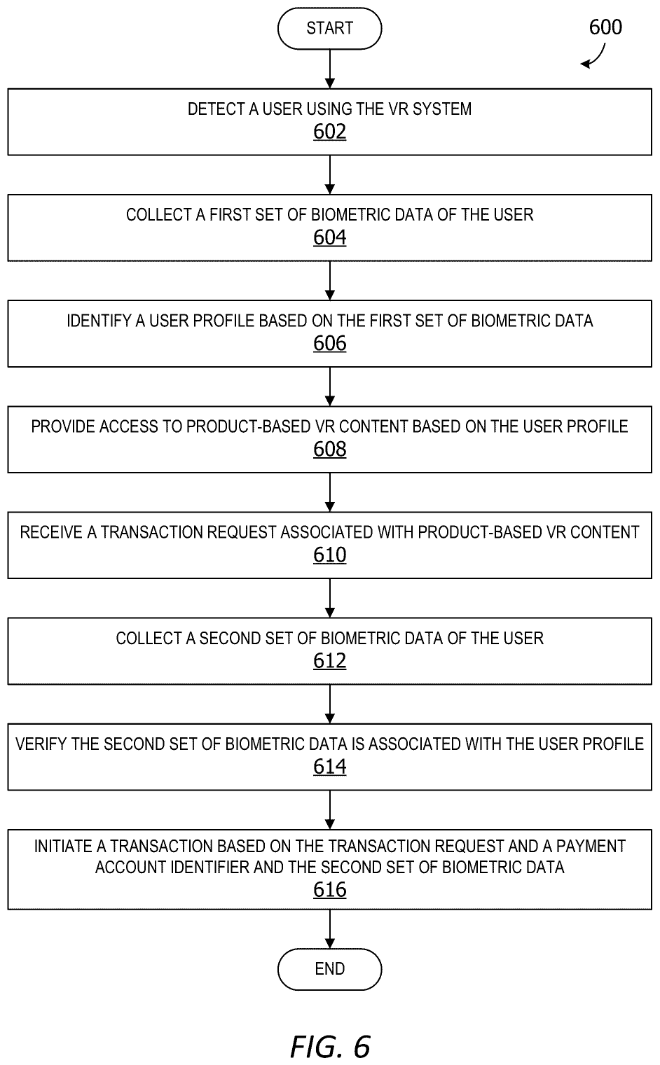

FIG. 6 is a flow chart illustrating a computerized method 600 for providing access to content and processing associated transactions via a virtual reality (VR) system according to an embodiment. In some examples, the computerized method 600 is executed or otherwise performed on a component or components of a system such as systems 100, 200, or 300 in FIGS. 1, 2, and 3, respectively. Additionally, in some examples, portions of the method 600 are performed in substantially the same manner as methods 400 and 500 described above.

With a VR system, users may be completely immersed in a computer-generated reality that is used for gaming, entertainment, or other uses. In many examples, users wear a head-mounted display, VR headset, goggles, or the like that gives users a sense of moving among virtual objects that are being displayed. Such VR hardware may be connected to a computing device (e.g., a personal computer, gaming console, or smartphone) or it may be a standalone VR headset device. Other uses of VR environments may include VR tools to help surgeons plan for and perform surgeries, VR environments to enable travelers to experience a destination before arrival, simulations to help children learn and experience things such as walking on the moon, and/or VR environments that help soldiers train for combat scenarios.

At 602, a user using the VR system is detected and, at 604, a first set of biometric data of the user is collected. In some examples, the detection of the user and collection of biometric data is performed using aspects or details specific to VR systems (e.g., detection of a user may include detecting when the VR goggles of the system are worn). Collection of biometric data using the VR system may include collection of types of biometric data that the VR system is suited to collecting, such as particular head movements, eye movements, or retinal data that the goggles of a VR system are configured to collect, or particular hand movements that can be collected using sensors of a handheld component of the VR system and/or cameras or other sensors that are configured to track hand movements and gestures without requiring use of handheld components.

At 606, a user profile is identified based on the first set of biometric data and access to product-based VR content is provided based on the identified user profile at 608. In some examples, 606 and 608 are performed in substantially the same way as 506 and 508 of method 500 as described above. Additionally, or alternatively, the product-based VR content may be adapted to take advantage of aspects specific to the VR system, such as content that includes a virtual store environment that enables the user to search a virtual store, find products, and view product information of products, including price information, sale information, price comparison information, product review information, or the like.

At 610, a transaction request associated with the product-based VR content is received and, at 612, a second set of biometric data of the user is collected based on the received transaction request. In some examples, 610 and 612 are performed in substantially the same way as 510 and 512 of method 500 described above. Additionally, or alternatively, the collection of the second set of biometric data may be based on specific aspects of the VR system, as with the collection of the first set of biometric data.

At 614, the association between the second set of biometric data and the user profile is verified and, based on a successful verification, a transaction based on the transaction request, a payment account identifier, and the second set of biometric data is initiated at 616. In some examples, 614 and 616 are performed in substantially the same way as 514 and 516 of method 500 described above. Further, in some examples, the method 600 includes the transformation of biometric data into biometric tokens as described herein.

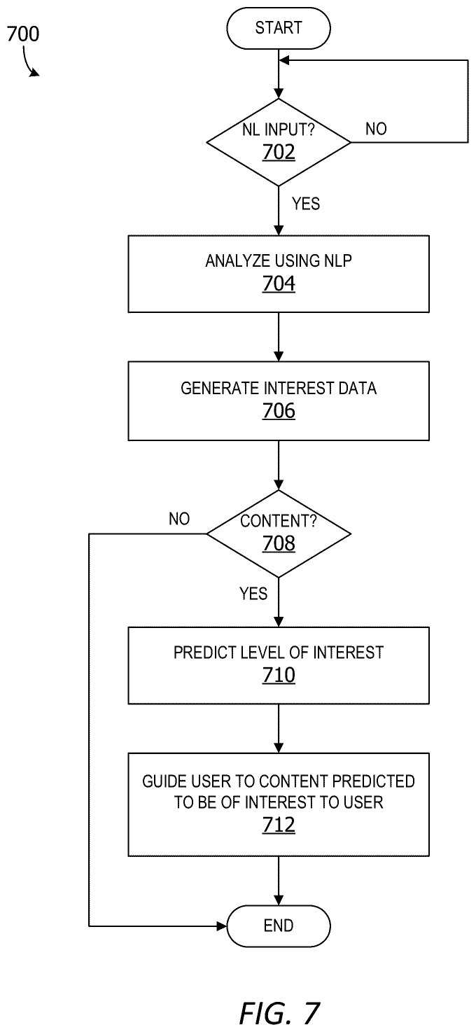

FIG. 7 is a flow chart illustrating a computerized method for guiding a user to content predicted to be of interest to the user based on interest data and historical user data. In some examples, the computerized method 600 is executed or otherwise performed on a component or components of a system such as systems 100, 200, or 300 in FIGS. 1, 2, and 3, respectively. Additionally, in some examples, portions of the method 600 are performed in substantially the same manner as methods 400 and 500 described above.

At 702, a determination is made whether natural language (NL) input is received from a user. The NL input can include spoken words, inquiries, search requests or other verbal instructions or questions. If yes, the NL input is analyzed using NLP at 704. Interest data is generated at 706. The interest data is data indicating the user interest in at least a portion of available content within the XR environment. The interest data, in some examples, is generated using data describing the content, historical data associated with the user, as well as any other relevant data.

A determination is made whether content is available at 708. The content is content which can be presented to the user based on the user's behavior, biometric data, NL input or other user input. If yes, a predicted level of user interest in the content is created at 710. The user is guided to content predicted to be of interest to the user at 712. The content is predicted to be of interest if the interest level and/or an interest score associated with the predicted interest level indicates likely user interest in at least a portion of the content based on a threshold.

In some examples, the XR system may also be a mixed reality (MR) system that includes features of both VR and AR systems to provide mixed sets of features. For instance, an MR system may go a step past AR systems toward being more immersive, such that a user is enabled to interact in real-time with virtual objects that are placed within the real world. These virtual objects may respond and react as if they were actual objects. Such systems may include MR headsets that are capable of offering a holographic experience through translucent glasses or similar hardware. It should be understood that the biometric functionality as described herein may be integrated into an MR system without departing from the description.

### Additional Example Scenarios

Aspects of the disclosure enable various additional scenarios, such as next described.

In an example, a parent obtains a VR system for use in their household by all the members of the family. Each parent uses the VR system to set up individual user profiles for themselves. The parents' user profiles are each linked to a set of VR content, including some VR environments to explore, VR games to play, and some VR store environments associated with specific businesses that they like. The parents' user profiles are further associated with a payment account that the parents share, such that, when one of the parents wants to buy something from within a VR environment of the VR system, they may do so using the associated payment account. Each of the parents' user profiles is associated with a biometric token that is based on each of the parents' behavioral biometrics, respectively.

One of the parents also configures a user profile for their child. The child's user profile is configured to include more limited access to content, including games and other content that is considered appropriate for children and VR store environments associated with stores that the child likes. Further, the child's user profile is associated with a limited payment account that is configured by the parent to have a balance associated with the child's allowance, enabling the child to make purchases up to the defined balance amount within a VR environment of the VR system. Further, the child's user profile is configured to notify the parents when the child requests a transaction that has not been pre-approved by the parents, such that the parents are prompted (e.g., via email or the like) to provide approval of the transaction prior to proceeding. To complete the configuration of the child's user profile, the child wears the VR goggle device of the VR system and performs some movements to calibrate the system to the child and capture an initial set of behavioral biometrics of the child for use in identifying the child in the future.

Once configured, the members of the family are enabled to wear the VR goggles and use other interfaces of the VR system to interact with VR content that is associated with their user profiles, respectively. While using the system, each family member can initiate transactions to purchase content or other products or services via the VR environments and using the payment accounts with which their user profiles are associated. Through capturing each family member's behavioral biometrics while they use the system, they are enabled to seamlessly access content and initiate transactions without any additional prompting or provision of other identifying information.

### Exemplary Operating Environment

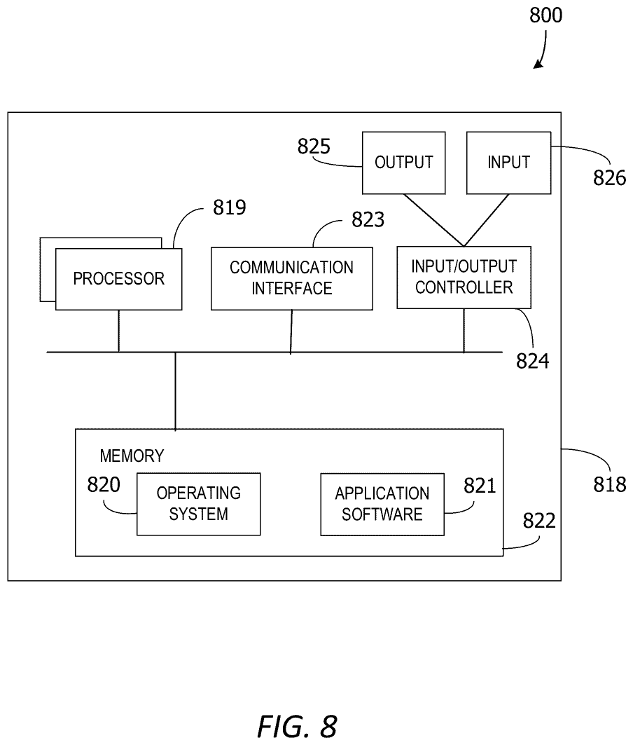

The present disclosure is operable with a computing apparatus according to an embodiment as a functional block diagram 800 in FIG. 8. In an embodiment, components of a computing apparatus 818 may be implemented as a part of an electronic device according to one or more embodiments described in this specification. The computing apparatus 818 comprises one or more processors 819 which may be microprocessors, controllers, or any other suitable type of processors for processing computer executable instructions to control the operation of the electronic device. Alternatively, or in addition, the processor 819 is any technology capable of executing logic or instructions, such as a hardcoded machine. Platform software comprising an operating system 820 or any other suitable platform software may be provided on the apparatus 818 to enable application software 821 to be executed on the device. According to an embodiment, providing access to content and facilitating transactions from within an XR system based on behavioral biometrics as described herein may be accomplished by software, hardware, and/or firmware.

Computer executable instructions may be provided using any computer-readable media that are accessible by the computing apparatus 818. Computer-readable media may include, for example, computer storage media such as a memory 822 and communications media. Computer storage media, such as a memory 822, include volatile and non-volatile, removable, and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 822) is shown within the computing apparatus 818, it will be appreciated by a person skilled in the art, that the storage may be distributed or located remotely and accessed via a network or other communication link (e.g. using a communication interface 823).

The computing apparatus 818 may comprise an input/output controller 824 configured to output information to one or more output devices 825, for example a display or a speaker, which may be separate from or integral to the electronic device. The input/output controller 824 may also be configured to receive and process an input from one or more input devices 826, for example, a keyboard, a microphone, or a touchpad. In one embodiment, the output device 825 may also act as the input device. An example of such a device may be a touch sensitive display. The input/output controller 824 may also output data to devices other than the output device, e.g. a locally connected printing device. In some embodiments, a user may provide input to the input device(s) 826 and/or receive output from the output device(s) 825.

The functionality described herein can be performed, at least in part, by one or more hardware logic components. According to an embodiment, the computing apparatus 818 is configured by the program code when executed by the processor 819 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system for enabling processing of transactions from within an extended reality (XR) system using behavioral biometrics comprises: at least one processor of the XR system; and at least one memory comprising computer program code, the at least one memory and the computer program code configured to, with the at least one processor, cause the at least one processor to: detect a user using the XR system; automatically collect a first set of biometric data of the user using the XR system based on the user being detected, the first set of biometric data including biometric data of at least one behavioral biometric data type; transform the first set of biometric data of the user into a first biometric token; identify a user profile based on the first biometric token, wherein the user profile is associated with a subset of content and a payment account identifier of a payment account; provide access to the subset of content to the user via the XR system based on the identified user profile; receive a transaction request associated with the provided access to the subset of content; based on the received transaction request, automatically collect a second set of biometric data of the user using the XR system, the second set of biometric data including biometric data of at least one behavioral biometric data type; transform the second set of biometric data of the user into a second biometric token; verify that the second biometric token is associated with the user profile; and based on verifying that the second biometric token is associated with the user profile, initiate a transaction based on the transaction request, the payment account identifier, and the second biometric token, whereby an identity of the user is authenticated based on the second biometric token and a transaction processing entity with which the transaction is initiated is configured to cause a transaction amount to be paid from the payment account based on the authentication of the identity of the user.

An example computerized method for enabling processing of transactions from within an extended reality (XR) system using behavioral biometrics comprises: detecting, by a processor, a user using the XR system; automatically collecting, by the processor, a first set of biometric data of the user using the XR system based on the user being detected, the first set of biometric data including biometric data of at least one behavioral biometric data type; transforming, by the processor, the first set of biometric data of the user into a first biometric token; identifying, by the processor, a user profile based on the first biometric token, wherein the user profile is associated with a subset of content and a payment account identifier of a payment account; providing, by the processor, access to the subset of content to the user via the XR system based on the identified user profile; receiving, by the processor, a transaction request associated with the provided access to the subset of content; based on the received transaction request, automatically collecting, by the processor, a second set of biometric data of the user using the XR system, the second set of biometric data including biometric data of at least one behavioral biometric data type; transforming, by the processor, the second set of biometric data of the user into a second biometric token; verifying, by the processor, that the second biometric token is associated with the user profile; and based on verifying that the second biometric token is associated with the user profile, initiating, by the processor, a transaction based on the transaction request, the payment account identifier, and the second biometric token, whereby an identity of the user is authenticated based on the second biometric token and a transaction processing entity with which the transaction is initiated is configured to cause a transaction amount to be paid from the payment account based on the authentication of the identity of the user.

One or more non-transitory computer storage media have computer-executable instructions for enabling processing of transactions from within an extended reality (XR) system using behavioral biometrics that, upon execution by a processor, cause the processor to at least: detect a user using the XR system; automatically collect a first set of biometric data of the user using the XR system based on the user being detected, the first set of biometric data including biometric data of at least one behavioral biometric data type; transform the first set of biometric data of the user into a first biometric token; identify a user profile based on the first biometric token, wherein the user profile is associated with a subset of content and a payment account identifier of a payment account; provide access to the subset of content to the user via the XR system based on the identified user profile; receive a transaction request associated with the provided access to the subset of content; based on the received transaction request, automatically collect a second set of biometric data of the user using the XR system, the second set of biometric data including biometric data of at least one behavioral biometric data type; transform the second set of biometric data of the user into a second biometric token; verify that the second biometric token is associated with the user profile; and based on verifying that the second biometric token is associated with the user profile, initiate a transaction based on the transaction request, the payment account identifier, and the second biometric token, whereby an identity of the user is authenticated based on the second biometric token and a transaction processing entity with which the transaction is initiated is configured to cause a transaction amount to be paid from the payment account based on the authentication of the identity of the user.

Alternatively, or in addition to the other examples described herein, examples include any combination of the following:
wherein the first set of biometric data and the second set of biometric data include biometric data of the at least one behavioral biometric data type of: user height determined based on user movement, user gait patterns, user head movement patterns, user hand gestures, or user body gestures;
wherein the first set of biometric data and the second set of biometric data further include, in combination with the biometric data of the at least one behavioral biometric data type, at least one other type of biometric data of: retinal biometric data, facial recognition biometric data, or fingerprint biometric data;
wherein the second set of biometric data includes biometric data types of the first set of biometric data and at least one additional type of biometric data that the first set of biometric data does not include;
wherein transforming the second set of biometric data into a second biometric token is based on a tokenization process associated with the transaction processing entity with which the transaction is initiated;
further comprising: detecting, by the processor, a second user using the XR system; automatically collecting, by the processor, a third set of biometric data of the second user using the XR system based on the second user being detected, the third set of biometric data including biometric data of at least one behavioral biometric data type; transforming, by the processor, the third set of biometric data of the user into a third biometric token; determining, by the processor, that the second user lacks a user profile based on the third biometric token; and providing, by the processor, access to a default subset of content to the second user via the XR system based on the second user lacking a user profile associated with the third biometric token;
wherein the XR system is an augmented reality (AR) system; wherein providing access to the subset of content to the user via the XR system includes providing product-based AR content to the user as the user views products in a store; and wherein receiving a transaction request associated with the provided access to the subset of content includes receiving a transaction request associated with a product that the user selects to purchase based on the provided product-based AR content;
wherein the XR system is a virtual reality (VR) system; wherein providing access to the subset of content to the user via the XR system includes providing product-based VR content to the user as the user views products in a virtual store; and wherein receiving a transaction request associated with the provided access to the subset of content includes receiving a transaction request associated with a product that the user selects to purchase based on the provided product-based VR content;
generate interest data associated with the of the user using the XR system, the interest data indicating a level of user interest associated with the subset of content, wherein an interest prediction module identifies at least a portion of content within the subset of content predicted to be of interest to the user;
guide the user to at least a portion of the content in the subset of content associated with educational content based on interest data generated by an artificial intelligence personal assistant;
analyze natural language input from the user, by a natural language processor (NLP) module to identify user feedback;
generate interest data associated with the of the user using the XR system based on the user feedback and the biometric data, the interest data indicating a level of user interest associated with the subset of content,;
wherein a learning module identifies at least a portion of content within the subset of content having educational content predicted to be of interest to the user;
receiving natural language input from the user; analyzing the natural language input, by a natural language processor (NLP) module to identify user feedback; and generating interest data associated with the of the user using the XR system based on the user feedback and the biometric data, the interest data indicating a level of user interest associated with the subset of content;
generating an interest score indicating a predicted level of user interest in at least a portion of the content within the subset of content based on the interest data of the user; and guiding the user to at least a portion of the content in the subset of content predicted to be of interest to the user based on the interest data associated with the user;
generating a recommendation, by a learning manager, indicating educational content within the subset of content predicted to be of interest to the user based on the user interest data and content data describing the subset of content and
analyze natural language input received from a user via NLP to identify user feedback; generate interest data associated with the of the user using the XR system based on the user feedback and the biometric data, the interest data indicating a level of user interest associated with the subset of content; generate a predicted level of user interest in at least a portion of the content within the subset of content based on the interest data of the user; and guide the user to the at least a portion of the content in the subset of content in response to the predicted level of user interest exceeding a threshold level.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for detecting, by a processor, a user using the XR system; exemplary means for automatically collecting, by the processor, a first set of biometric data of the user using the XR system based on the user being detected, the first set of biometric data including biometric data of at least one behavioral biometric data type; exemplary means for transforming, by the processor, the first set of biometric data of the user into a first biometric token; exemplary means for identifying, by the processor, a user profile based on the first biometric token, wherein the user profile is associated with a subset of content and a payment account identifier of a payment account; exemplary means for providing, by the processor, access to the subset of content to the user via the XR system based on the identified user profile; exemplary means for receiving, by the processor, a transaction request associated with the provided access to the subset of content; based on the received transaction request, exemplary means for automatically collecting, by the processor, a second set of biometric data of the user using the XR system, the second set of biometric data including biometric data of at least one behavioral biometric data type; exemplary means for transforming, by the processor, the second set of biometric data of the user into a second biometric token; exemplary means for verifying, by the processor, that the second biometric token is associated with the user profile; and based on verifying that the second biometric token is associated with the user profile, exemplary means for initiating, by the processor, a transaction based on the transaction request, the payment account identifier, and the second biometric token, whereby an identity of the user is authenticated based on the second biometric token and a transaction processing entity with which the transaction is initiated is configured to cause a transaction amount to be paid from the payment account based on the authentication of the identity of the user.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computer system for authenticating a user using an extended reality (XR) system using behavioral biometrics, the computer system comprising:
a processor; and
a memory storing software arranged to execute on the processor, the software comprising instructions operative upon execution by the processor to:
detect the user using the XR system,
based on detecting the user using the XR system, automatically collect a first set of passive behavioral biometric data in a background of the user using the XR system via a sensor of the XR system, and
based on matching the first set of passive behavioral biometric data to a second set of passive behavioral biometric data stored in the XR system, authenticate the user to access a subset of content and payment data in an XR environment of the XR system, thereby enabling the user to request a transaction within the XR environment.

2. The system of claim 1, wherein the instructions are further operative upon execution by the processor to:
based on detecting the user using the XR system, automatically collect a third set of passive behavioral biometric data in the background of the user using the XR system via the sensor,
wherein authenticating the user to access a subset of content and payment data is further based on matching the third set of passive behavioral biometric data to the second set of passive behavioral biometric data.

3. The system of claim 2,
wherein the first set of passive behavioral biometric data is a gesture pattern of the user,
wherein the third set of passive behavioral biometric data is an eye movement pattern of the user, and
wherein the second set of passive behavioral biometric data comprises eye movement pattern data and head movement pattern data.

4. The system of claim 3,
wherein the first set of passive behavioral biometric data further comprises a walking gait pattern of the user,
wherein the third set of passive behavioral biometric data further comprises a hand movement pattern of the user, and
wherein the second set of passive behavioral biometric data further comprises walking gait pattern data and hand movement pattern data.

5. The system of claim 1, wherein the instructions are further operative upon execution by the processor to:
based on the user requesting a transaction within the XR environment, automatically collect a first set of passive biometric data of the user and a second set of passive biometric data of the user, wherein the sets of passive biometric data are captured without specific interaction by the user with the XR environment; and
based on matching the first set of passive biometric data and the second set of passive biometric data to a second set of passive biometric data stored in the XR system, send transaction request data and the payment data to a transaction processing entity.

6. The system of claim 5,
wherein the first set of passive biometric data comprises a retinal pattern of an eye of the user, and
wherein the second set of passive biometric data comprises facial recognition data captured while the user is wearing a headgear of the XR system.

7. The system of claim 6,
wherein the first set of passive biometric data further comprises a height of the user, and
wherein the second set of passive biometric data further comprises data a shape and a proportion of the user.

8. The system of claim 1, further comprising:
a secure hardware chip distinct from the memory,
wherein the secure hardware chip stores the second set of passive behavioral biometric data, and
wherein matching the first set of passive behavioral biometric data to the second set of passive behavioral biometric data occurs on the secure hardware chip, such that it is insulated from other processes being performed on the XR system.

9. The system of claim 8, wherein the instructions are further operative upon execution by the processor to:
apply a hash function to the first set of passive behavioral biometric data and the second set of passive behavioral biometric data in a consistent manner, resulting in a first behavioral biometric token and a second behavioral biometric token that can directly compared to determine whether the first set of passive behavioral biometric data matches the second set of passive behavioral biometric data.

10. The system of claim 9, wherein matching the first set of passive behavioral biometric data to the second set of passive behavioral biometric data further comprises:
determine whether the first behavioral biometric token matches the second behavioral biometric token within a defined confidence threshold,
wherein all data values of the sets of behavioral biometric data are separately tokenized according to behavioral biometric data type.

11. A computerized method for authenticating a user using an extended reality (XR) system using behavioral biometrics, the computerized method comprising:
detecting the user using the XR system,
based on detecting the user using the XR system, automatically collecting a first set of passive behavioral biometric data in a background of the user using the XR system via a sensor of the XR system, and
based on matching the first set of passive behavioral biometric data to a second set of passive behavioral biometric data stored in the XR system, authenticating the user to access a subset of content and payment data in an XR environment of the XR system, thereby enabling the user to request a transaction within the XR environment.

12. The computerized method of claim 11, further comprising:
based on detecting the user using the XR system, automatically collecting a third set of passive behavioral biometric data in the background of the user using the XR system via the sensor,
wherein authenticating the user to access a subset of content and payment data is further based on matching the third set of passive behavioral biometric data to the second set of passive behavioral biometric data.

13. The computerized method of claim 12,
wherein the first set of passive behavioral biometric data is a gesture pattern of the user,
wherein the third set of passive behavioral biometric data is an eye movement pattern of the user, and
wherein the second set of passive behavioral biometric data comprises eye movement pattern data and head movement pattern data.

14. The computerized method of claim 13,
wherein the first set of passive behavioral biometric data further comprises a walking gait pattern of the user,
wherein the third set of passive behavioral biometric data further comprises a hand movement pattern of the user, and
wherein the second set of passive behavioral biometric data further comprises walking gait pattern data and hand movement pattern data.

15. The computerized method of claim 11, further comprising:
based on the user requesting a transaction within the XR environment, automatically collecting a first set of passive biometric data of the user and a second set of passive biometric data of the user, wherein the sets of passive biometric data are captured without specific interaction by the user with the XR environment; and
based on matching the first set of passive biometric data and the second set of passive biometric data to a third set of passive biometric data stored in the XR system, sending transaction request data and the payment data to a transaction processing entity.

16. The computerized method of claim 15,
wherein the first set of passive biometric data comprises a retinal pattern of an eye of the user, and
wherein the second set of passive biometric data comprises facial recognition data captured while the user is wearing a headgear of the XR system.

17. The computerized method of claim 16,
wherein the first set of passive biometric data further comprises a height of the user, and
wherein the second set of passive biometric data further comprises data of a the shape and a proportion of the user.

18. The computerized method of claim 11, further comprising:
applying a hash function to the first set of passive behavioral biometric data and the second set of passive behavioral biometric data in a consistent manner, resulting in a first behavioral biometric token and a second behavioral biometric token that can directly compared to determine whether the first set of passive behavioral biometric data matches the second set of passive behavioral biometric data,
wherein matching the first set of passive behavioral biometric data to the second set of passive behavioral biometric data occurs on a secure hardware chip that it insulated from other processes performed by the XR system.

19. The computerized method of claim 18, wherein matching the first set of passive behavioral biometric data to the second set of passive behavioral biometric data further comprises:
determining whether the first behavioral biometric token matches the second behavioral biometric token within a defined confidence threshold,
wherein all data values of the sets of behavioral biometric data are separately tokenized according to behavioral biometric data type.

20. An extended reality (XR) headgear device comprising:
an eye-tracking camera;
a retinal scanning sensor; and
a secure hardware processing chip storing a first set of eye movement pattern data and a first set of retinal scan data,
wherein the XR device has computer-executable instructions that, upon execution by a processor, cause the processor to at least:
detect a user using the XR device,
automatically collect a second set of eye movement pattern data of the user with the eye-tracking camera in a background while the user is interacting with an XR environment of the XR device,
match the second set of eye movement pattern data to the first set of passive behavioral biometric data via the secure hardware processing chip,
based on matching the second set of eye movement pattern data to the first set of eye movement pattern data, authenticate the user to access to a subset of content and payment data in the XR environment, thereby enabling the user to request a transaction within the XR environment,
based on the user requesting the transaction within the XR environment, automatically collect a second set of retinal scan data of the user, wherein the retinal scan data is captured without specific interaction by the user with the XR environment, and
based on matching the second set of retinal scan data to the first set of retinal scan data stored in the secure hardware processing chip, send transaction request data and the payment data to a transaction processing entity.
